(19) United States
(12) Patent Application Publication
(10) Pub. No.: US 2006/0097528 A1
(43) Pub. Date: May 11, 2006

(54) Automotive vehicle dent guard panels

(76) Inventors: Sylvia Green Southerland, Raleigh, NC (US); William Edward Carter, Raleigh, NC (US)

Correspondence Address: Sylvia G. Southerland, 1130-303 Carlton Avenue, Raleigh, NC, 27606, US

(21) Appl. No.: 10/983,289

(22) Filed: Nov. 8, 2004

(51) Int. Cl. B60R 19/42

(52) U.S. Cl. 293/128

(57) ABSTRACT

The present invention in its preferred archetype is an automotive dent guard comprising of a vehicle molds of a front quarter and door panel (1) a rear door and quarter panel (2), a conjoined foldout front quarter and door panel and a rear door and quarter panel (3) and slip clip (4). The translucent vinyl protective devices have a generally flat surface on one side and translucent vinyl shock absorbing stem protrusions on the opposite side (1), (2) and (3) that fit the left and right side of the vehicle. The dent guard panels provide effective and lightweight protection, preventing dings and unwarranted scratches to the exterior of a parked vehicle. The slip clip device (4) and suction cups secure the door and quarter panel dent guards. The dent guards will be essential to vehicle owners, easily manufactured, and circulated through automotive part distribution companies.

### CROSS-REFERENCE RELATED APPLICATIONS

U.S. Pat. No. 3,540,773 November, 1970 Settle 296/152. U.S. Pat. No. 3,610,684 October, 1971 Ritcher 296/152. U.S. Pat. No. 4,643,471 February, 1987 Fishback 293/128.

### STATEMENT REGARDING FEDERALLY SPONSORED RESEARCH AND DEVELOPMENT

Not Applicable.

### REFERENCE TO A SEQUENCE LISTING, A TABLE, OR A COMPUTER PROGRAM LISTING

Not Applicable.

### BACKGROUND OF THE INVENTION

The present invention is equipment for automobile use, particularly for exterior use as a protective device for vehicle doors.

The protective device consists of molds of a vehicle front door and quarter panel, a rear door and quarter panel with a secure flap, and a fold out panel consisting of a front door and quarter panel conjoined with a rear door and rear quarter panel with a secure flap. The dent guard panels are also secured with slip clips and suction cups. The dent guard panels are used to maintain vehicle value by preventing and minimizing dents, dings, scrapes and scratches.

There are other devices that have been revealed such as the automotive vehicle “Dent Protection” device, is described in U.S. Pat. No. 4,643,471 issued to William Fishback on Feb. 17, 1987. This device consists of elongated rectangular shock absorbing elements. The elements contain pouches to insert materials for shock absorbency and are hung in a saddlebag manner over the vehicle for protection.

The “Retractable vehicle Door Protector,” is described in U.S. Pat. No. 3,540,773 issued to Benjamin Settle on Nov. 17, 1970. The device is retractable, but requires permanent components to ensure adequate positioning.

The “Protective Cover,” is described in U.S. Pat. No. 3,610,684, issued to Dudley Richter on Oct. 5, 1971. The protective sheet can be hooked on a vehicle door and removed. The device provides limited coverage protection.

In conclusion, many of the previous disclosed inventions experience critical disadvantages. In addition they have limited protection coverage, are cumbersome, and are not lightweight.

### BRIEF SUMMARY OF THE INVENTION

Automobiles, trucks, and other vehicular means are the primary source of transportation. Individuals consider these means of transportation as an investment and necessary to maintain their independence and livelihood. Therefore, a device to maintain vehicle appearance by preventing dings unwarranted nasty scrapes and scratches would be of great benefit to consumers. Individuals can attach dent guards after parking at the local mall or any location. No more parking away and walking to a destination or hoping for ding prevention by double parking.

The archetypes of the present automotive invention are dent guard panels. The operative translucent vinyl mold elements of the present invention are a vehicle front quarter panel, front door, a rear door, and a rear quarter panel.

The front door and quarter panel is conjoined with hinges and secured with suction cups and slip clips. The rear door and quarter panel is conjoined with hinges and secured with slip clips, suction cups and a vinyl flap. The fold out panel is a conjoined vehicle front door and quarter panel, a rear door and quarter panel with support components consisting of slip clips, suction cups and a vinyl flap. The dent guards provide the necessary shock absorbency and protection to prevent dents while parked in narrow parking spaces, shield rocks and debris, and prevent nasty quarter panel and door damage.

The present invention provides effective vehicle protection.

The present invention is easily and quickly affixed.

The present invention is collapsible and can be easily removed and stored.

The present invention is standard or can be customized for any vehicle.

The present invention is a simple and affordable design for the average consumer.

The present invention can be quickly produced and easily manufactured.

The value and advantages of this invention will become evident in the invention completion process and drawing illustrations.

### BRIEF DESCRIPTION OF THE SEVERAL VIEWS OF THE DRAWING

FIG. 1 is a right side view of the present invention, the front quarter dent guard panel with a secure flap and slip clips.

FIG. 2 is a right side view of the present invention, the rear quarter dent guard panel with slip clips.

FIG. 3 is a side view of the present invention, the conjoined fold out dent guard panel, with a secure flap and slip slips.

FIG. 4 is a view of the dent guard's shock absorbing stems.

FIG. 5 is a close view of the present invention, the slip clip device.

FIG. 6 is a close view of the quarter panel suction cup.

### DETAILED DESCRIPTION OF THE INVENTION

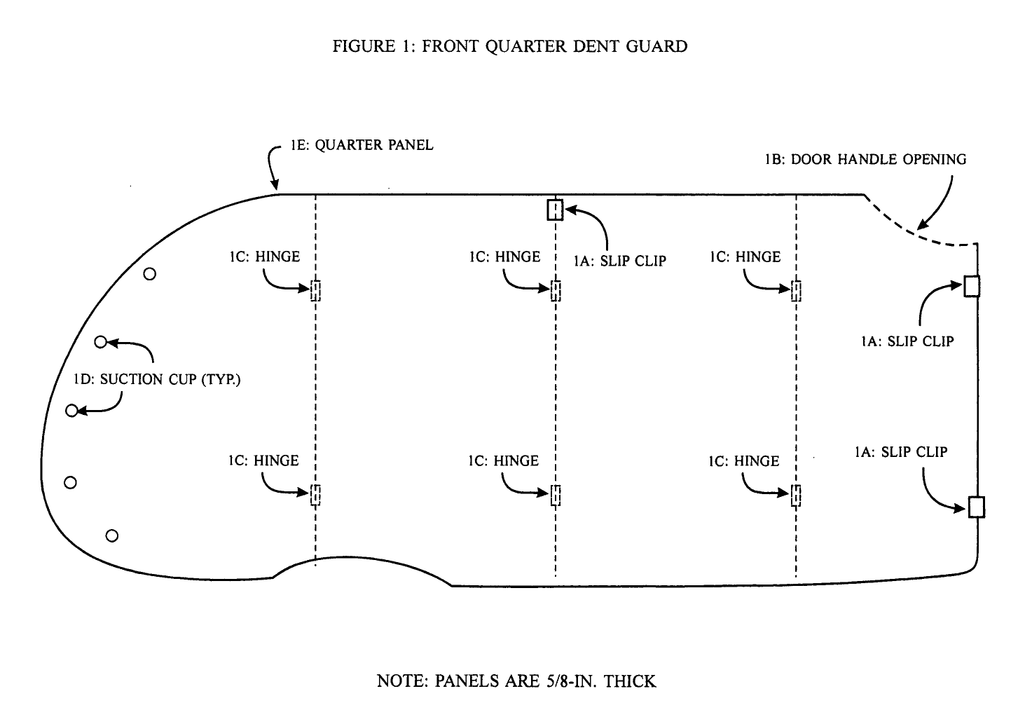

The present invention consists of vehicle dent guard protection panels. The preferred depiction, as shown in the provided FIGS. 1, 2, 3, and 4 are adaptable or can be customized for any vehicle door. The primary components are element 1 and second element 2, and third element 3, and fourth element 4.

The first step is to construct a standard vehicle front quarter and door panel molds. Translucent vinyl is inserted into the molds to form the dent guards that are generally flat on one side with wedge-shaped stem protrusions on the opposite side and suction cup supports. The front quarter and door dent guard panels are each cut in half and reconnected with vinyl hinges. The completed front quarter dent guard panel is illustrated in FIG. 1.

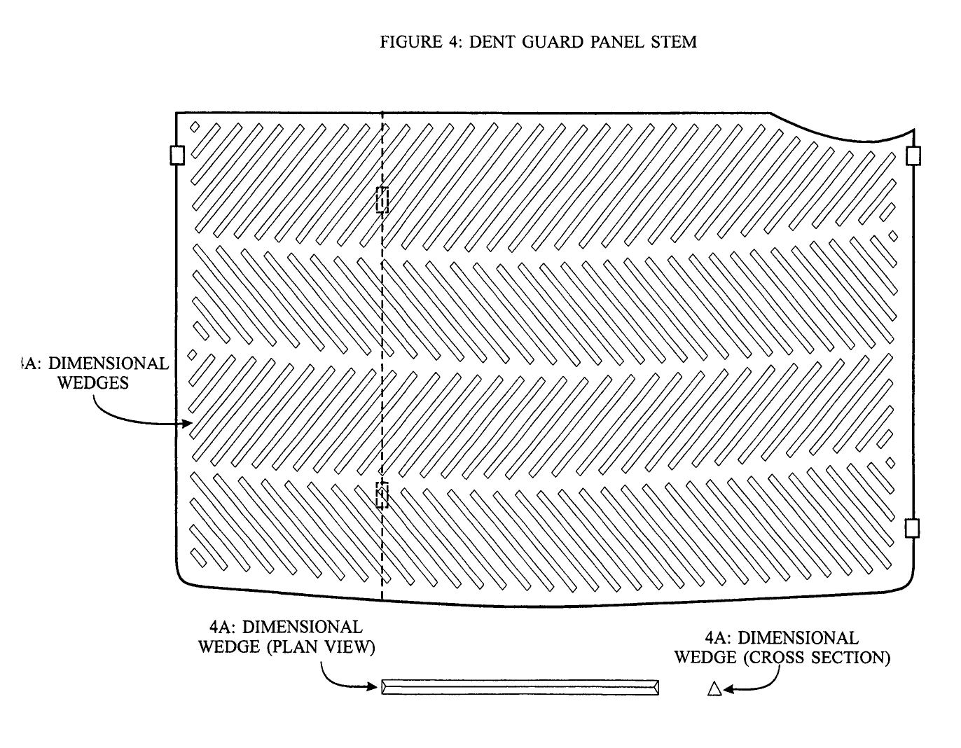

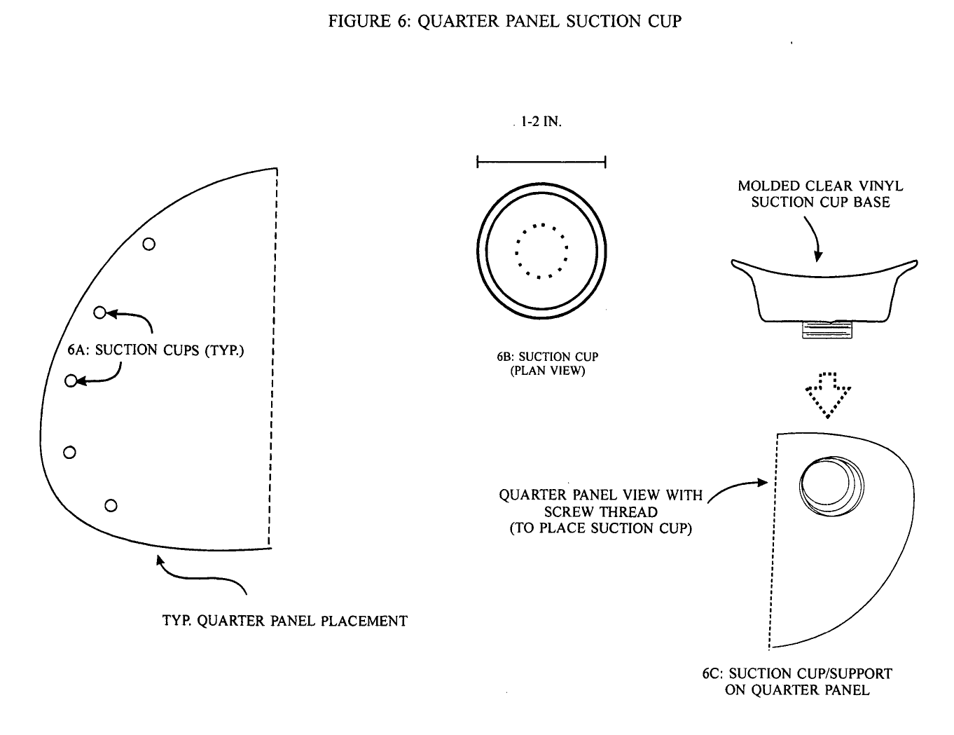

Primary element 1 is comprised of a ⅝ inch thick vinyl vehicle front quarter panel and door conjoined in FIG. 1. The quarter panels that has a generally flat surface on one side and has wedge-shaped translucent vinyl shock absorbing stem protrusions on the opposite side in FIG. 4 that are ¼ inch in height and ¼ inch in width, ranging from 1-20 inch(es) in length and suction cup supports. The vehicle front quarter dent guard panel is secured with slip clips and suction cups in FIGS. 1, 5, and 6. The vinyl suction cups are screwed into the supports located on the dent guard panel. The suction cups are replaceable and can be positioned as needed in FIG. 6. The dent guard has 1-inch vinyl hinges in FIG. 1 that conjoins and allows the element to fold out, collapse, or be disassembled for use of the front door dent guard only option.

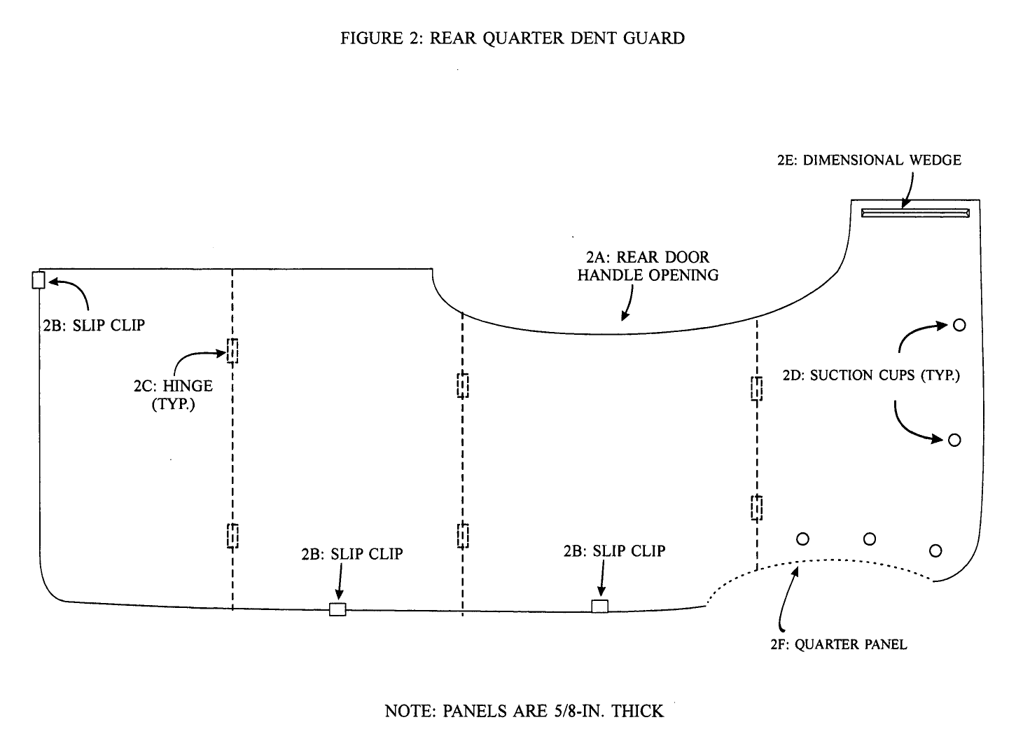

The second step is to construct molds of a standard vehicle rear door and quarter panel with a secure flap. Translucent vinyl is inserted into the molds to form the dent guard protection device that is generally flat on one side with wedge-shaped stem protrusions on the opposite side and suction cup supports. The rear door and quarter dent guard panels are each cut in half and reconnected with vinyl hinges. The completed rear quarter dent guard panel is illustrated in FIG. 2.

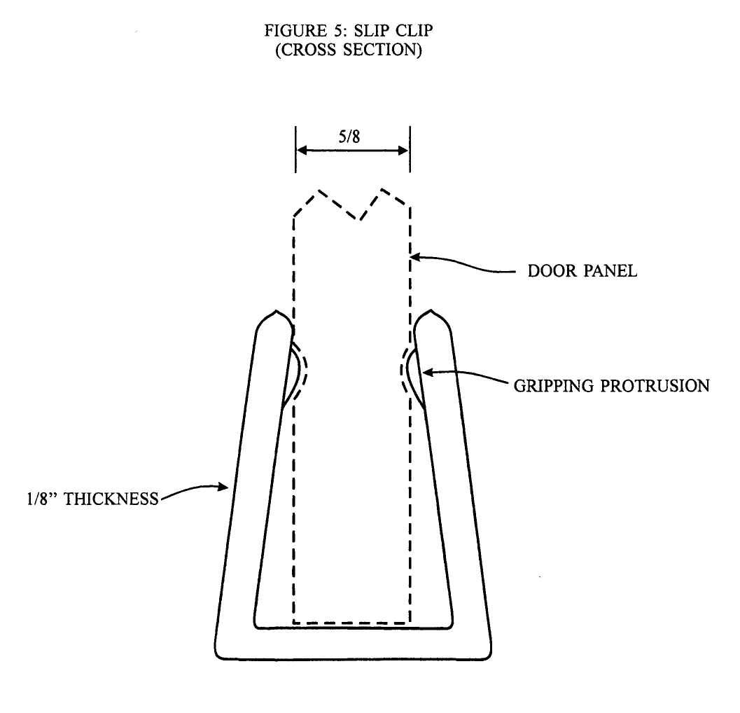

Secondary element 2 is comprised of a ⅝ inch thick translucent vinyl vehicle rear door and quarter panel conjoined in FIG. 2 that has a generally flat surface on one side and has wedge-shaped translucent vinyl shock absorbing stem protrusions on the opposite side in FIG. 4 that are ¼ inch in height and ¼ inch in width, ranging from 1-20 inch(es) in length and suction cup supports. The rear quarter dent guard panel is secured with slip clips in FIGS. 2 and 5 and suction cups in FIG. 6, and a translucent vinyl panel flap in FIG. 2 is 12 inches wide and 8 inches in length, located on the end of the dent guard closest to the rear of the vehicle. The vinyl suction cups are screwed into the supports located on the dent guard panel. The suction cups are replaceable and can be positioned as needed in FIG. 6. The translucent vinyl flap is placed into the trunk of the vehicle to ensure support of the device. The dent guard has 1-inch vinyl hinges in FIG. 1 that conjoins and allows the element to fold out, collapse, or be disassembled for use of the rear door dent guard only option.

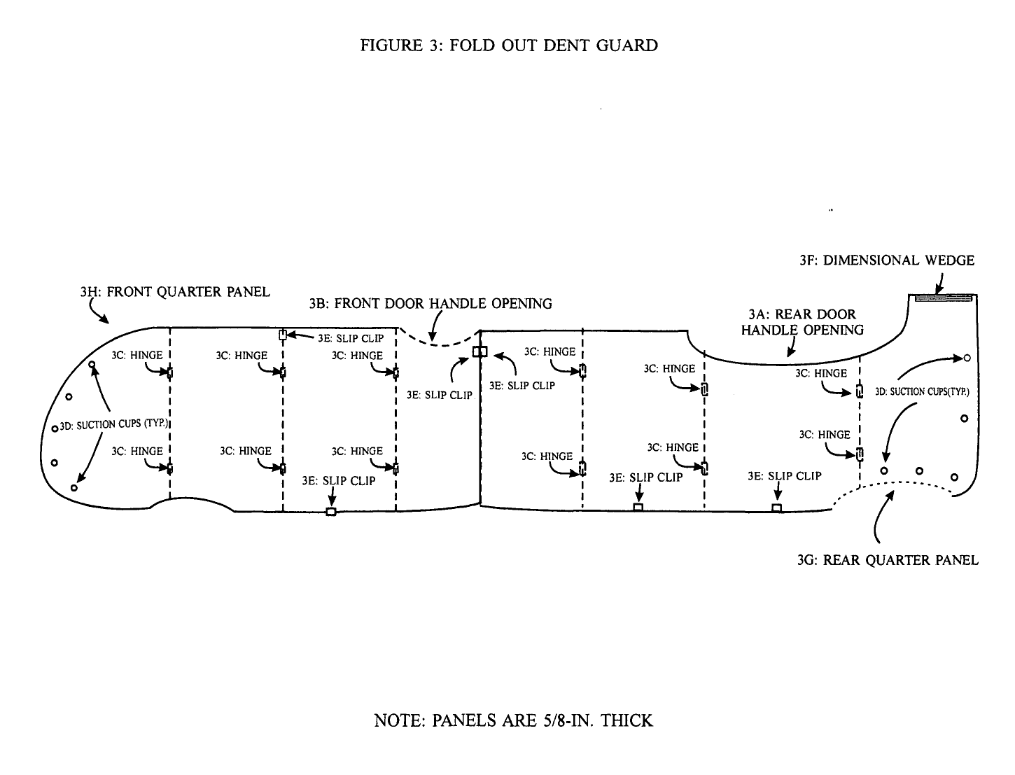

The third step is to construct a mold of a vehicle front door and quarter panel and rear door and quarter panel, with a secure flap. Translucent vinyl is inserted into the molds to form the dent guard protection device that is generally flat on one side with wedge-shaped stem protrusions on the opposite side and suction cup supports. The vehicle front door and quarter panel and rear door and quarter panel are each cut in half and reconnected with vinyl hinges. The completed fold out dent guard panel is illustrated in FIG. 3.

Thirdly, element 3 is comprised of a ⅝ inch thick translucent vinyl vehicle front door and quarter panel and rear door and quarter panel conjoined in FIG. 3 that has a generally flat surface on one side and has wedge-shaped translucent vinyl shock absorbing stem protrusions on the opposite side in FIG. 4 are ¼ inch in height and ¼ inch in width, ranging from 1-20 inch(es) in length and suction cup supports. The fold out dent guard panel is secured with slip clips in FIG. 5, suction cups in FIG. 6, and a translucent vinyl panel flap in FIG. 3 is 12 inches wide and 8 inches in length, which is connected to the end of the dent guard closest to the rear of the vehicle. The vinyl suction cups are screwed into the supports located on the dent guard panel. The suction cups are replaceable and can be positioned as needed in FIG. 6. The translucent vinyl flap is placed into the trunk of the vehicle to ensure support of the device. The dent guard has 1-inch vinyl hinges in FIG. 1 that conjoins and allows the element to fold out, collapse, or be disassembled for use of the front and rear door dent guard only option.

Fourth, element 4 is comprised of a translucent plastic formed slip clip. Translucent plastic is inserted into the mold to form the slip clip device that is three-sided with one opening. The slip clip is used to secure the dent guard panels to the vehicle. The completed slip clip device is illustrated in FIG. 5.

The fourth step is to create a slip clip in FIG. 5 formed by translucent plastic. Translucent plastic is inserted into a mold to form the slip clip device that is 3 inches in length and width and is ⅛ inch thick, but varies dependent the upon vehicle. The slip clip has three sides and an opening 1-1½ inch(es) with a grip protrusion feature inside, which allows the device to slip and lock onto the dent guards for security. The completed slip clip is illustrated in FIG. 5.

Fifth, element 5 is comprised of a soft translucent vinyl suction cup. Translucent vinyl is inserted into the mold to form the suction cup with screw threads in FIG. 6 used to secure the front and rear quarter dent guard panel to the vehicle. The completed suction cup is illustrated in FIG. 6.

The fifth step is to create a suction cup in FIG. 6 formed by translucent vinyl. Translucent vinyl is inserted into a mold for the suction cup that ranges from 1 to 3 inches in diameter. The vinyl suction cup base has screw threads that allow the element to be screwed onto the dent guard panels to provide additional support. The suction cups can be repositioned on the dent guard panels as necessary.

In order for the dent guards to be removed and stored, they must be unsecured by opening the vehicle doors and removing the secured slip clips in from the interior of the vehicle doors and suction cups from the front and rear quarter panels. The dent guards can be collapsed and stored in their storage unit for future use.

Individuals in specialized skilled areas will continually analyze, improve or modify the art. Therefore, the disclosed information provided on the invention is not limited. The claims are provided as an interpretation and essence of the invention.

What is claimed is:

1. An automotive dent guard, comprising of;
What we claim as our invention is first, a standard translucent vinyl vehicle front door and quarter panel. The front quarter dent guard panel provides protective coverage to the vehicle front quarter panel and door. The dent guard is secured with suction cups, one slip clip placed on the top end of the dent guard and front vehicle door from the exterior left side, and one slip clip placed on the top and bottom right side of the vehicle door and suction cups located on the front end of the quarter panel. Said guard device has car handle and key accessibility and can be installed or removed easily therefrom; and
What we claim as our invention is second, a standard translucent vinyl vehicle rear door and quarter panel, with a secure flap. The rear quarter dent guard panel provides protective body coverage to the vehicle rear door and quarter panel. The dent guard is secured with one slip clip placed on the top end of the dent guard and vehicle door from the left side and two slip clips placed on the bottom of the vehicle door, suction cups, and a translucent vinyl flap are located on the rear end of the quarter panel. The translucent vinyl quarter panel flap is located at the end of the dent guard closest to the rear of the vehicle and is placed into the trunk or hatch of the vehicle to ensure support of the device. Said guard device has car handle and key accessibility and can be installed or removed easily therefrom; and
What we claim as our invention is third, a standard translucent vinyl vehicle front panel and door and a rear door and quarter panel with a secure flap. The fold out dent guard panel provides full-side vehicle protective body coverage. The front quarter panel is secured with suction cups, the door is secured with one slip clip placed on the top end of the dent guard and front vehicle door from the exterior left side, one slip clip placed on the bottom of the front door and one slip clip placed on the top end of the dent guard and rear door, two slip clips are placed on the bottom, suction cups located on the rear end of the quarter panel, and a translucent vinyl quarter panel flap is located on the rear end of the dent guard panel. The vinyl translucent flap is placed into the trunk of the vehicle to ensure support of the device. Said guard device has car handle and key accessibility and can be installed or removed easily therefrom; and
What we claim as our invention is fourth; a slip clip formed from translucent plastic. The slip clip secures the dent guard panels to the vehicle doors. The dent guard panels are secured with slip clips from the end that would be located left, right and bottom facing the exterior vehicle doors.

2. The device of claim 1 wherein;
We claim the translucent vinyl front quarter dent guard panel formed from a ⅝ inch thick vehicle front quarter panel and door molds that have a generally flat surface on one side and has wedge-shaped shaped translucent vinyl shock absorbing stem protrusions on the opposite side that are ¼ inch in height and ¼ inch in width, ranging from 1-20 inch(es) in length and suction cup supports. The front quarter dent guard panel is secured with suction cups and slip clips. The device has 1-inch vinyl hinges that conjoin and allow the front quarter dent guard panel to fold out, collapse, or be disassembled for use of the front door dent guard only option.

3. The device of claim 2 wherein;
We claim the translucent vinyl rear quarter dent guard panel formed from a ⅝ inch thick vehicle rear door and quarter panel molds that have a generally flat surface on one side and has translucent vinyl shock absorbing wedge-shaped stem protrusions on the opposite side that are ¼ inch in height and ¼ inch in width, ranging from 1-20 inch(es) in length, suction cup supports, and a secure flap. The rear quarter dent guard panel is secured with slip clips, suction cups, and a vinyl secure flap located at the rear end of the dent guard. The secure flap is 12 inches in width and 8 inches in length. The device has 1-inch vinyl hinges that conjoin and allow the rear quarter dent guard panel to fold out, collapse, or be disassembled for use of the rear door dent guard only option.

4. The device of claim 3 wherein;
We claim the translucent vinyl fold out dent guard panel formed from a ⅝ inch thick front vehicle door and quarter panel and rear door and quarter panel molds that have a generally flat surface on one side and has wedge-shaped shaped translucent vinyl shock absorbing shaped stem protrusions on the opposite side that are ¼ inch in height and ¼ inch in width, ranging from 1-20 inch(es) in length in length, suction cup supports, and a secure flap. The fold out dent guard panel is secured with slip clips, suction cups, and a vinyl secure flap located at the rear end of the dent guard. The secure flap is 12 inches in width and 8 inches in length The device has 1-inch vinyl hinges that conjoin and allow the fold out dent guard panel to fold out, collapse, or be disassembled for use of the front and/or rear door dent guard only option.

5. The device of claim 4 wherein;
We claim the said slip clips are formed with firm translucent vinyl. The slip clip device is formed by a mold that is 3 inches in length and width. The slip clip is ⅛ inch thick, but varies dependent upon vehicle. The slip clip has an opening 1-1½ inch(es) in width, with a slight grip protrusion feature inside that allows the apparatus to slip and lock onto the dent guard for security.
